(19) United States
(12) Patent Application Publication
(10) Pub. No.: US 2025/0045798 A1
(43) Pub. Date: Feb. 6, 2025

(54) INFORMATION PROCESSING APPARATUS AND INFORMATION PROCESSING METHOD

(71) Applicant: INFIC Inc., Shizuoka (JP)

(72) Inventor: Masatoshi MASUDA, Shizuoka (JP)

(21) Appl. No.: 18/926,323

(22) Filed: Oct. 25, 2024

Related U.S. Application Data
(63) Continuation of application No. PCT/JP2023/012783, filed on Mar. 29, 2023.

(30) Foreign Application Priority Data
Apr. 26, 2022 (JP) 2022-072089

(51) Int. Cl. G06Q 30/0251

(52) U.S. Cl. CPC G06Q 30/0255

(57) ABSTRACT

An information processing apparatus includes: an acquisition part that acquires personal data indicating an attribute of a user; a classification part that determines a classification of the user using the personal data; a determination part that determines a timing at which information about a service offered to the user is notified, the timing corresponding to a relationship between the classification and the service; and a notification part that provides the information about the service to the user at the timing.

### CROSS-REFERENCE TO RELATED APPLICATIONS

The present application is a continuation application of International Application number PCT/JP2023/12783, filed on Mar. 29, 2023, which claims priority under 35 U.S.C § 119 (a) to Japanese Patent Application No. 2022-072089, filed on Apr. 26, 2022, contents of which are incorporated herein by reference in their entirety.

### BACKGROUND OF THE INVENTION

The present disclosure relates to an information processing apparatus and an information processing method for providing information about a service offered to a user. Japanese Unexamined Patent Application Publication No. 2021-33643 describes a system that transmits proposals regarding life events such as end-of-life planning to an information terminal used by a user on the basis of the number of years that have passed since the family was formed, the ages of the user's family members, and the like.

The user's circumstances, such as assets he/she owns, his/her lifestyle habits, and his/her family structure differ greatly from person to person. For this reason, even if a service such as end-of-life planning is proposed on the basis of the user's age, the service may not be implemented because the timing of proposing the service does not match the user's circumstances.

### BRIEF SUMMARY OF THE INVENTION

The present disclosure focus on this point, and its object is to enable providing notification of information about a service offered to a user at a timing suitable for the user.

An information processing apparatus according to a first aspect of the present disclosure includes: an acquisition part that acquires personal data indicating an attribute of a user; a classification part that determines a classification of the user by using the personal data; a determination part that determines a timing at which information about a service offered to the user is provided as notification, the timing corresponding to a relationship between the classification and the service; and a notification part that provides the information about the service to the user at the timing.

An information processing method according to a second aspect of the present disclosure is executed by a processor and including: acquiring personal data indicating an attribute of a user; determining a classification of the user using the personal data; determining a timing at which information about a service offered to the user is provided as notification, the timing corresponding to a relationship between the classification and the service; and providing the information about the service to the user at the timing.

An information processing apparatus according to a third aspect of the present disclosure includes: an acquisition part that acquires personal data indicating an attribute of a user and measurement data generated by measuring activities of the user; a classification part that determines a classification of the user using the personal data; and a notification part that provides information about a service offered to the user at a timing when a relationship between a value of the measurement data and a reference value corresponding to the classification satisfies a predetermined condition.

An information processing method according to a fourth aspect of the present disclosure is executed by a processor and including: acquiring personal data indicating an attribute of a user; acquiring measurement data generated by measuring activities of the user; determining a classification of the user using the personal data; and providing information about a service offered to the user at a timing when a relationship between a value of the measurement data and a reference value corresponding to the classification satisfies a predetermined condition.

### BRIEF DESCRIPTION OF THE DRAWINGS

FIG. 1 is a diagram illustrating an outline of an information processing system according to a first embodiment.

FIG. 2 is a block diagram of the information processing system according to the first embodiment.

FIG. 3 is a schematic diagram for explaining a method by which a classification part determines a classification of a user.

FIG. 4A is a schematic diagram of an exemplary first rule showing a relationship between (i) values of personal data and measurement data and (ii) evaluation coefficients.

FIG. 4B is a schematic diagram of an exemplary first rule showing a relationship between (i) values of personal data and measurement data and (ii) evaluation coefficients.

FIG. 5 is a schematic diagram of the exemplary first rule showing the relationship between (i) values of personal data and measurement data and (ii) evaluation coefficients.

FIG. 6 is a schematic diagram for explaining a method by which a determination part determines a notification timing.

FIG. 7 is a schematic diagram for explaining a method by which a notification part provides notification of service information.

FIG. 8 is a flowchart of an information processing method executed by an information processing apparatus according to the first embodiment.

FIG. 9 is a schematic diagram for explaining a method by which the determination part determines the notification timing.

FIG. 10 is a flowchart of an information processing method executed by an information processing apparatus according to a second embodiment.

FIG. 11 is a schematic diagram for explaining a method of notification by the notification part.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### First Embodiment

### [Outline of an Information Processing System S]

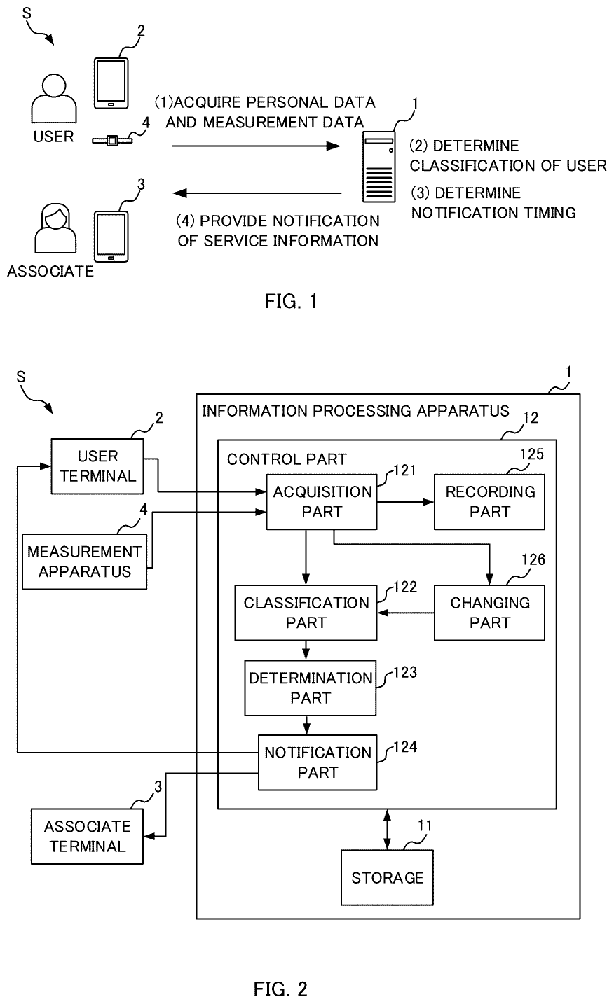

FIG. 1 is a diagram illustrating an outline of an information processing system S according to the present embodiment. The information processing system S includes an information processing apparatus 1, a user terminal 2, an associate terminal 3, and a measurement apparatus 4. The information processing system S may include a plurality of user terminals 2, a plurality of associate terminals 3, and a plurality of measurement apparatuses 4. The information processing system S may include devices such as other servers and terminals.

The information processing apparatus 1 is a computer that provides service information about services offered to a user to the user or a user's associate. The information processing apparatus 1 provides, for example, information about an end-of-life planning service that supports the user with preparing for his/her end-of-life (i.e., preparation for the end of one's life), a daily living support service that assists with the user's daily life, an after-death support service that assists the user's associate with procedures after the death of the user, and the like. The information processing apparatus 1 communicates wirelessly or by wire between the user terminal 2, the associate terminal 3, and the measurement apparatus 4.

The user terminal 2 is an information terminal used by the user, and is a smartphone, a tablet terminal, or a personal computer. The user is a person who receives the information about the services from the information processing system S. The user terminal 2 includes a display part such as a liquid crystal display that displays the information to the user, and an operation part such as a touch panel that receives an operation performed by the user.

The associate terminal 3 is an information terminal such as a smartphone, a tablet terminal, a personal computer, or the like, which is used by the user's associate. The associate is an individual associated with the user, e.g., a family member, a guardian, or the like. One user may be associated with a plurality of associates. The associate terminal 3 includes a display part such as a liquid crystal display that displays information to the associate, and an operation part such as a touch panel that receives an operation performed by the associate.

The measurement apparatus 4 is an apparatus that generates measurement data by measuring activities of the user. The measurement apparatus 4 is associated with the user, who is a measurement target, in advance. One user may be associated with a plurality of measurement apparatuses 4. The measurement apparatus 4 is a motion sensor installed in a living room of the user, a bed sensor installed in a bed where the user sleeps, a smart watch worn by the user, or the like, for example.

An outline of a process executed by the information processing system S according to the present embodiment will be described below. The information processing apparatus 1 acquires personal data indicating an attribute of the user and the measurement data generated by measuring the activities of the user (1). The personal data indicates a date of birth, gender, a birthplace, a residential location, family structure, and the like of the user, for example. The measurement data indicates the user's movements, sleep duration or pulse, and the temperature, humidity, illuminance, or the like of an environment that includes the user, for example.

The information processing apparatus 1 determines a classification of the user using the personal data (2). The information processing apparatus 1 determines the classification of the user by applying classification rules stored in advance to one or a plurality of values included in the personal data. The information processing apparatus 1 may determine the classification of the user using the measurement data in addition to the personal data.

The information processing apparatus 1 determines a notification timing corresponding to a relationship between the determined classification of the user and the service offered to the user (3). For example, the greater the amount of assets of the user indicated by the personal data, the earlier the information processing apparatus 1 sets the notification timing. In addition, the information processing apparatus 1 sets the notification timing to be earlier for a user who is living alone, as indicated by the personal data, than for a user who is not living alone, for example.

The information processing apparatus 1 provides notification of the service information to the user at the determined notification timing (4). The service information is information including the description of content of services, identification information (a URI (Uniform Resource Identifier)) for using the services, or the like, for example. The information processing apparatus 1 transmits the service information to the user terminal 2 via a network, for example. The information processing apparatus 1 may provide notification about the service information to the user's associate instead of or in addition to the user.

As described above, the information processing apparatus 1 determines the classification of the user using the personal data of the user, and determines the notification timing according to the relationship between the determined classification and the service about which notification is to be provided. In this way, the information processing apparatus 1 can provide the information about the service offered to the user at a timing suitable for the user

### [Configuration of the Information Processing System S]

FIG. 2 is a block diagram of the information processing system S according to the present embodiment. In FIG. 2, arrows represent main data flows, and there may be data flows other than those depicted in FIG. 2. In FIG. 2, each block represents not the configuration of a piece of hardware (apparatus), but the configuration of a function. Therefore, blocks depicted in FIG. 2 may be implemented in a single apparatus, or may be implemented separately in a plurality of apparatuses. Data exchange between the blocks may be performed via any means such as a data bus, a network, or a portable storage medium.

The information processing apparatus 1 includes a storage 11 and a control part 12. The information processing apparatus 1 may be configured by connecting two or more physically separated apparatuses by a wire or wirelessly. The information processing apparatus 1 may be configured by cloud computing using a set of computer resources.

The storage 11 is a storage medium including a ROM (Read Only Memory), a RAM (Random Access Memory), a hard disk drive, or the like. The storage 11 has stored thereon in advance programs to be executed by the control part 12. The storage 11 may be provided outside the information processing apparatus 1, and in that case, may exchange data with the control part 12 via a network.

The control part 12 includes an acquisition part 121, a classification part 122, a determination part 123, a notification part 124, a recording part 125, and a changing part 126. The control part 12 is a processor such as a CPU (Central Processing Unit), and functions as the acquisition part 121, the classification part 122, the determination part 123, the notification part 124, the recording part 125, and the changing part 126 by executing the programs stored in the storage 11. At least some of the functions of the control part 12 may be realized by the control part 12 executing programs to be executed through the network.

Hereinafter, a process executed by the information processing apparatus 1 will be described in detail. In the information processing apparatus 1, the acquisition part 121 acquires the personal data indicating the attribute of the user. The acquisition part 121 is not limited to acquiring one type (item) of the personal data, and may acquire a plurality of types of personal data.

The personal data indicates at least one of the date of birth, gender, birthplace, residential location, and family structure of the user, for example. Further, the personal data may indicate at least one of asset information, interests, hobbies, preferences, friendships, behavior history, and purchase history of the user. In addition, the personal data may indicate ADL (Activities of Daily Living) information that is an index of movements which can be performed by the user. In addition, the personal data may include information indicating whether or not the user wishes to receive a specific service. The personal data is not limited to the specific types of information shown here, and may indicate other types of information corresponding to the attribute of the user.

For example, the acquisition part 121 receives information (for example, an answer to a questionnaire) input in the user terminal 2 or the associate terminal 3, and acquires personal data indicated by the received information. The acquisition part 121 may receive personal data from another apparatus (for example, a server that manages registration information of the user) that stores the personal data of the user.

The acquisition part 121 acquires the measurement data generated by measuring the activities of the user. The measurement data indicates at least one of the user's movement (such as the number of steps), sleep duration, or pulse, or the temperature, humidity, or illuminance of the environment that includes the user, for example. The measurement data is not limited to the specific types of information shown herein and may indicate other types of information corresponding to the user's activity.

The measurement apparatus 4 generates the measurement data by measuring activities of the user. The measurement apparatus 4 transmits the measurement data to the information processing apparatus 1 every time the measurement data is generated, or collectively transmits the measurement data of a predetermined period (one hour, one day, or the like) to the information processing apparatus 1 via the network. In the information processing apparatus 1, the acquisition part 121 receives the measurement data transmitted by the measurement apparatus 4.

The classification part 122 determines the classification of the user using the personal data and the measurement data acquired by the acquisition part 121. The classification of the user is a group for determining the timing at which notification of the service information is provided to the user. The classification part 122 may determine the classification of the user using only the personal data without using the measurement data.

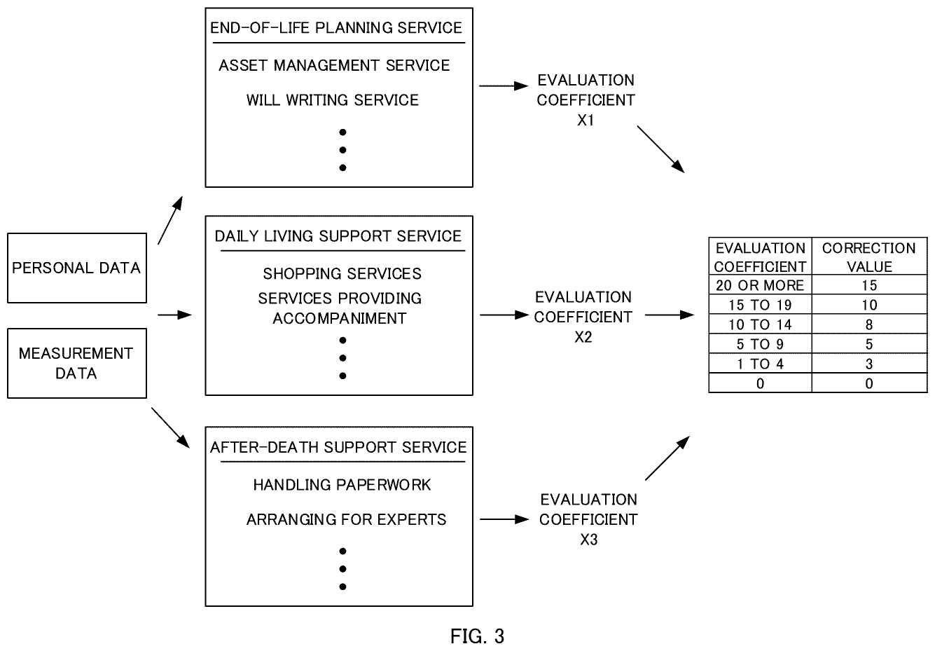

FIG. 3 is a schematic diagram for explaining a method by which the classification part 122 determines the classification of the user. The classification part 122 determines the classification of the user by applying the classification rules stored in advance in the storage 11 to one or a plurality of values included in the personal data and the measurement data.

The classification rules are the rules for determining the classification of the user using the personal data and the measurement data defined for each of a plurality of services. The classification rules include a first rule for calculating an evaluation coefficient from the values included in the personal data and the measurement data, and a second rule for determining the classification of the user from the calculated evaluation coefficient, for example.

The classification part 122 determines the classification of the user for each of a plurality of services including the end-of-life planning service, the daily living support service, and the after-death support service, for example. The end-of-life planning service is a service that supports the user with preparing for his/her end-of-life, and is, for example, an asset management service that manages the user's assets, a will writing service that creates the user's will, or the like. The daily living support service is a service that assists with the user's daily life, and is, for example, shopping services such as shopping on behalf of the user, a mail-order service, and the like, or services providing accompaniment to hospitals and stores. The after-death support service is a service that assists the user's associate with procedures after the death of the user, and is, for example, handling paperwork for public institutions or financial institutions or arranging for experts in inheritance, asset organization, and similar matters.

The classification part 122 is not limited to determining the specific services shown here and may also determine the classification of the user for other services offered to the user.

The classification part 122 acquires the classification rules of each of the plurality of services stored in advance in the storage 11. The classification part 122 calculates evaluation coefficients (X1, X2, and X3 in FIG. 3) of the plurality of services for which notification is to be provided from the personal data and the measurement data acquired by the acquisition part 121, according to the first rule among the acquired classification rules. The first rule is a table indicating a relationship between (i) values of one or more types of the personal data and the measurement data that are different among a plurality of services and (ii) evaluation coefficients, for example.

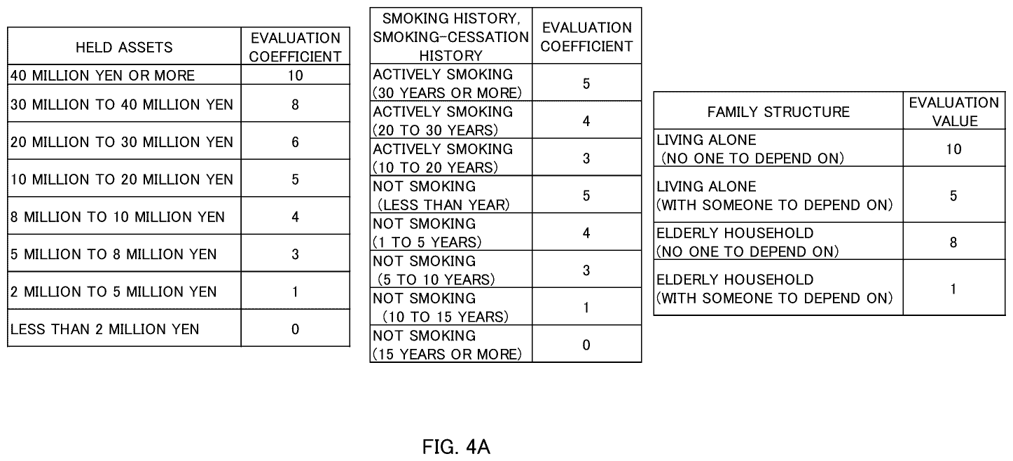

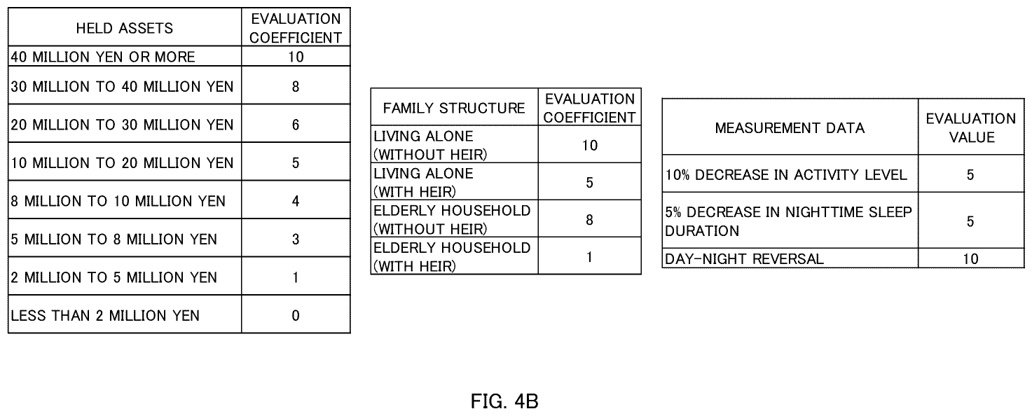

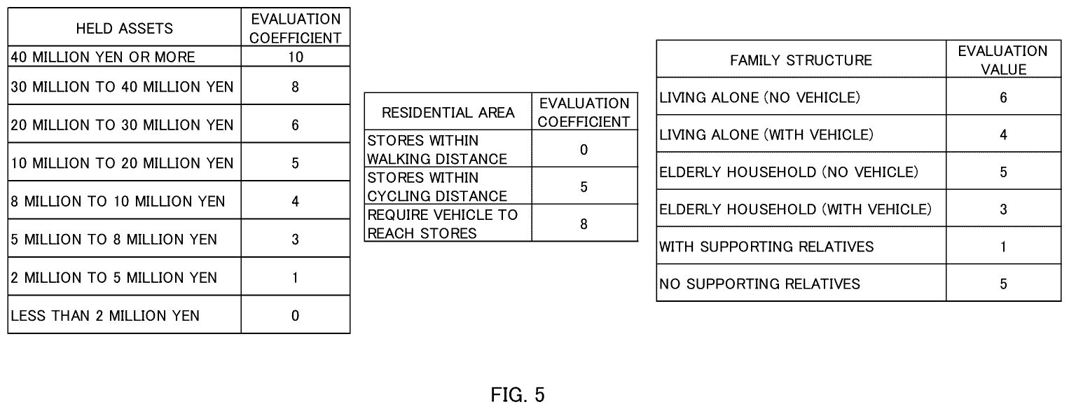

FIG. 4A, FIG. 4B, and FIG. 5 are each a schematic diagram of an exemplary first rule showing a relationship between (i) the values of the personal data and the measurement data and (ii) the evaluation coefficients. The first rule exemplified in FIGS. 4A, 4B, and 5 is represented such that a range of values of each item includes the lower limit value and excludes the upper limit value (for example, “2 million to 5 million yen” represents greater than or equal to 2 million yen and less than 5 million yen). Further, the range of values of each item may be defined in a manner to exclude the lower limit value and include the upper limit value.

FIG. 4A shows a first rule of the asset management service. In the example of FIG. 4A, the first rule shows the relationship between (i) held assets, smoking history or smoking cessation history, and family structure, and (ii) evaluation coefficients. In accordance with the first rule, the classification part 122 calculates a total value of the evaluation coefficients associated with each of the held assets, the smoking history or the smoking cessation history, and the family structure from among a plurality of types of personal data acquired by the acquisition part 121, as an evaluation coefficient in the asset management service. In a case where values of the personal data correspond to a plurality of items in the first rule (for example, a user who has smoked for 10 years and quit smoking for 5 years), the classification part 122 may use a total value of evaluation coefficients for the corresponding plurality of items.

FIG. 4B shows a first rule of the will writing service. In the example of FIG. 4B, the first rule shows the relationship between (i) held assets, family structure, and measurement data and (ii) evaluation coefficients. In accordance with the first rule, the classification part 122 calculates a total value of (i) the evaluation coefficients associated with each of the held assets and the family structure from among the plurality of types of personal data acquired by the acquisition part 121 and (ii) the evaluation coefficients associated with the measurement data acquired by the acquisition part 121, as an evaluation coefficient in the will writing service.

In the example of FIG. 4B, the first rule includes an amount of change in the measurement data. The classification part 122 calculates the amount of change in activity level (e.g., the number of steps) and in a nighttime sleep duration indicated by the measurement data acquired by the acquisition part 121, and uses an evaluation coefficient associated with the calculated amount of change, for example. The amount of change is represented by a difference from an average value over the past predetermined period (e.g., three months), for example.

FIG. 5 shows a first rule of the shopping services. In the example of FIG. 5, the first rule indicates the relationship between (i) held assets, residential area, and family structure and (ii) evaluation coefficients. In accordance with the first rule, the classification part 122 calculates a total value of (i) evaluation coefficients associated with each of the held assets, the residential area, and the family structure from among the plurality of types of personal data acquired by the acquisition part 121, as an evaluation coefficient in the shopping services. When values of the personal data correspond to the plurality of items in the first rule (for example, in the case of a user who is an elderly person belonging to an elderly household (with no vehicle) and having no supporting relatives), the classification part 122 may use a total value of the evaluation coefficients of the plurality of items.

As shown in FIGS. 4A, 4B, and 5, the classification part 122 may determine the classification of the user in each of the plurality of services using different types of personal data among the plurality of services. In this way, the information processing apparatus 1 can adjust the type of personal data used to determine the notification timing for each service, allowing it to more appropriately determine the notification timing of each of the plurality of services.

In addition, the classification part 122 may calculate evaluation coefficients that are different among the plurality of services and correspond to the values of the personal data. That is, the evaluation coefficients associated with the same types of personal data may be different among the plurality of services. For example, the evaluation coefficients associated with the family structure used in the asset management service shown in FIG. 4A are different from the evaluation coefficients associated with the family structure used in the shopping service shown in FIG. 5. In this way, the information processing apparatus 1 can adjust values of the evaluation coefficients associated with the values of the personal data in each service, allowing it to determine the notification timing of each of the plurality of services more appropriately.

Returning to FIG. 3, the classification part 122 determines the classification of the user corresponding to the evaluation coefficients calculated in each of the plurality of services, according to the second rule among the acquired classification rules. The second rule is a table indicating a relationship between ranges of the evaluation coefficients and correction values, for example. The range of one evaluation coefficient in the second rule corresponds to the classification of one user.

In the second rule, the classification part 122 determines a range in which the evaluation coefficients calculated in each of the plurality of services are included as the classification of the user in said services. Then, in the second rule, the classification part 122 acquires the correction values associated with the classification of the user in each of the plurality of services.

For example, the classification part 122 calculates the evaluation coefficient of the asset management service to be 18 for a user having 10 million yen of held assets, living alone (with no family), and having ceased smoking for 8 years. In the second rule exemplified in FIG. 3, the classification part 122 determines a range of the evaluation coefficients 15 to 19, including the evaluation coefficient 18, as the classification of this user, and acquires a correction value of 10 associated with said range. In addition, the classification part 122 calculates the evaluation coefficient of the will writing service to be 13 for a user having 5 million yen of held assets, living alone (with an heir), and having a 10% decrease in the activity level, for example. In the second rule exemplified in FIG. 3, the classification part 122 determines a range of the evaluation coefficients 10 to 14,including the evaluation coefficient 13, as the classification of this user, and acquires the correction value of 8 associated with said range.

In addition, the classification part 122 calculates the evaluation coefficient of the shopping service to be 23, for a user having 15 million yen of held assets, requiring a vehicle to reach stores, belonging to an elderly household (no vehicle), and having no supporting relatives, for example. In the second rule exemplified in FIG. 3, the classification part 122 determines a range of the evaluation coefficients 20 or greater, including the evaluation coefficient 23, as the classification of this user, and acquires the correction value of 15 associated with said range.

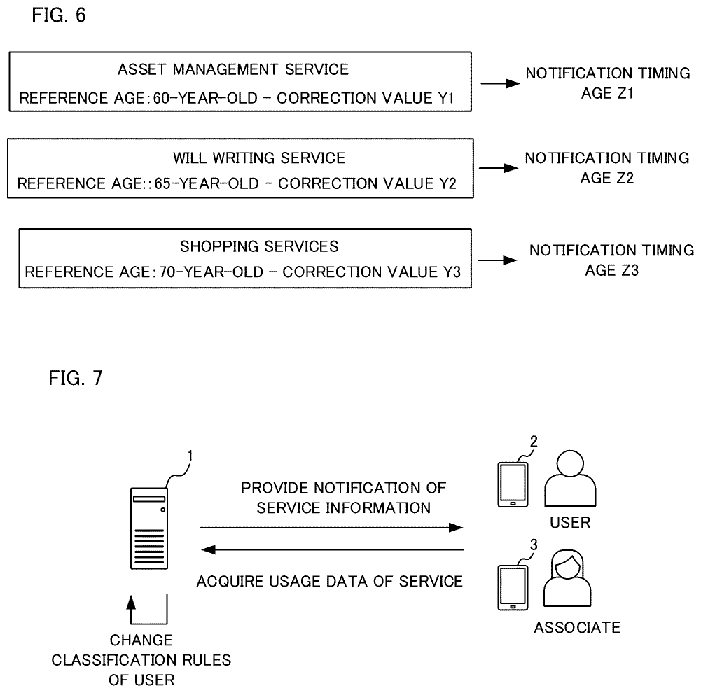

The determination part 123 determines the notification timing corresponding to a relationship between the classification of the user determined by the classification part 122 and the service offered to the user. FIG. 6 is a schematic diagram for explaining a method of determining the notification timing performed by the determination part 123.

The determination part 123 acquires reference values of each of the plurality of services stored in advance in the storage 11. The reference value, for example, is the age of the user used as a reference for the notification timing at which the service is notified. The reference values may be the same for the plurality of services or may be different among the plurality of services.

The determination part 123 calculates the ages (Z1, Z2, and Z3 in FIG. 6), which are the notification timings, by subtracting the correction values (Y1, Y2, and Y3 in FIG. 6) associated with the classification of the user in the service from reference ages, which are the reference values associated with each of the plurality of services. Instead of the reference ages, the determination part 123 may calculate dates, which are the notification timings, by subtracting the correction values from reference dates, which are the reference values associated with each of the plurality of services.

In the examples shown in FIGS. 4A, 4B, and 5, the greater the amount of assets (held assets) of the user indicated by the personal data, the earlier the determination part 123 sets the notification timing, and the lesser the amount of assets, the later the determination part 123 sets the notification timing. In addition, in the examples shown in FIGS. 4A, 4B, and 5, the determination part 123 sets the notification timing to be earlier for the user who is indicated by the personal data to live alone or to belong to an elderly household than for the user who is indicated by the personal data to not live alone or to not belong to an elderly household.

In addition, in the example shown in FIG. 4B, the determination part 123 sets the timing for the user whose measurement data indicates a decrease in his/her activity level or nighttime sleep duration to be earlier than the timing for the user whose measurement data indicates that his/her activity level or nighttime sleep duration has not decreased.

The determination part 123 may determine the notification timing on the basis of not only the specific criteria shown here but also on other criteria using the personal data and measurement data.

The notification part 124 provides the service information about the services to the user at the notification timings determined for each of the plurality of services by the determination part 123. The notification part 124 may provide the service information to the user's associate in addition to the user.

FIG. 7 is a schematic diagram for explaining a method by which the notification part 124 provides the service information. The notification part 124 transmits the service information to the user terminal 2 or the associate terminal 3 using email, a messaging service, an SNS (Social Networking Service), or the like, on condition that the notification timing determined by the determination part 123 has been reached (for example, the user turned the age which is the notification timing).

Further, instead of or in addition to transmitting the service information via the network, the notification part 124 may output, to a printing apparatus, information (for example, the content of the service information and the address of the user or the user's associate) for sending the service information to the user or the user's associate by printing the service information on a paper medium. In this case, the paper medium on which the service information is printed is sent to the user or the user's associate. The notification part 124 is not limited to transmitting the service information via the network or sending the paper medium, and may provide the service information to the user or the user's associate by other methods.

The service information is information including the description of content of services or the URI for using the services, for example. The notification part 124 may determine content of the service information according to at least one of the personal data or the measurement data, and provide the service information including the determined content. In this case, the notification part 124 provides service information including different types of asset management services according to the amount of held assets indicated by the personal data, for example. In this way, the information processing apparatus 1 can provide the service information having the content suitable for the user according to content of the personal data or the measurement data.

In addition, the notification part 124 may switch a notification recipient of the service information between the user and the user's associate in accordance with each of the plurality of services. In this case, the notification part 124 acquires information indicating notification recipients of each of the plurality of services stored in advance in the storage 11, and switches the notification recipients of each of the plurality of services in accordance with the acquired information. For example, the notification part 124 notifies only the user of the service information about the daily living support service, and notifies both the user and the user's associate of the service information about the end-of-life planning service. In this way, the information processing apparatus 1 can provide the service information to the notification recipient suitable for each service.

After the notification part 124 has notified the user or the user's associate of the service information, the acquisition part 121 acquires usage data regarding whether the user or the user's associate has used the service indicated by the service information provided in the notification. The usage data is data indicating, for example, having used a service, having applied for a service, having implemented a service, content entered for a service, or the like. For example, the acquisition part 121 receives a usage history of the service from the user terminal 2 or the associate terminal 3, and acquires the usage data on the basis of the received usage history. The acquisition part 121 may receive usage data from another apparatus (for example, a server that provides the service) that stores the usage data.

The recording part 125 may record the usage data acquired by the acquisition part 121 by using blockchain. The recording part 125 generates an NFT (Non-Fungible Token) associated with the usage data and the user or the user's associate by executing a known token generation process on the usage data (a will created by the will writing service), for example. The recording part 125 records the generated NFT in a storage medium connected to the network using the blockchain. By doing this, since the recording part 125 can associate the usage data with the user or the user's associate using the NFT that is difficult to tamper with, the relationship between the usage data and the user or the user's associate can be recorded more reliably.

After the notification part 124 has notified the user or the user's associate of the service information, the changing part 126 may change the classification rules for the classification part 122 to classify the user on the basis of the usage data acquired by the acquisition part 121. For example, the changing part 126 determines the evaluation coefficients included in the classification rules so as to increase the number of users or user's associates who use the service, by executing a known machine learning process on (i) whether the user or user's associate indicated by a plurality of pieces of usage data acquired in the past by the acquisition part 121 has used the service and (ii) the evaluation coefficients used at the time when the service information related to the usage data was notified. The changing part 126 is not limited to the specific method shown here, and other methods capable of changing the evaluation coefficients according to the usage data may be used. The changing part 126 stores the changed classification rules in the storage 11.

In this way, the information processing apparatus 1 adjusts the evaluation coefficients according to whether the service was used after providing notification of the service information to the user or the user's associate, and therefore can determine a more effective notification timing.

### [Flow of the Information Processing Method]

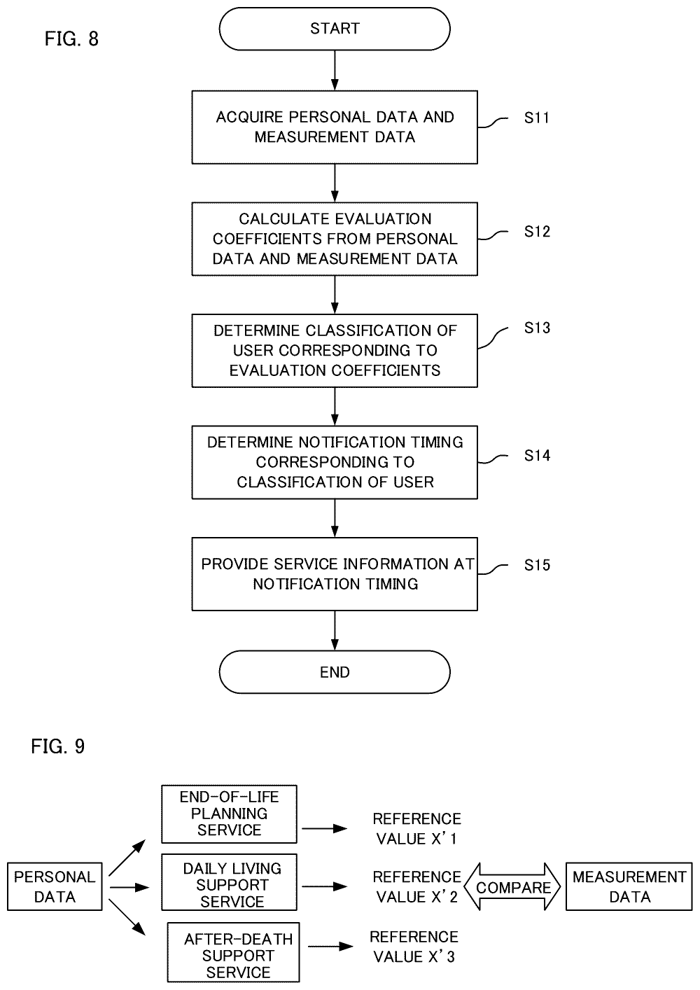

FIG. 8 is a flowchart of an information processing method executed by the information processing apparatus 1 according to the present embodiment. The acquisition part 121 acquires personal data indicating an attribute of a user and measurement data generated by measuring activities of the user (S11). The acquisition part 121 receives the personal data from a user terminal 2, an associate terminal 3, or another apparatus, for example. In addition, the acquisition part 121 receives the measurement data from the measurement apparatus 4 or another apparatus, for example.

The classification part 122 acquires classification rules of each of the plurality of services stored in advance in the storage 11. The classification part 122 calculates evaluation coefficients of each of the plurality of services for which notification is to be provided from the personal data and the measurement data acquired by the acquisition part 121, according to the acquired classification rules (S12). The classification part 122 determines a classification of the user corresponding to the evaluation coefficients calculated in each of the plurality of services according to the acquired classification rules (S13).

The determination part 123 determines a notification timing corresponding to a relationship between the classification of the user determined by the classification part 122 and a service offered to the user (S14). The determination part 123 acquires reference ages, which are the reference values of each of the plurality of services, stored in advance in the storage 11, for example. The determination part 123 calculates the ages, which are the notification timings, by subtracting correction values associated with the classification of the user in the service from the reference ages, which are the reference values associated with each of the plurality of services.

The notification part 124 provides the service information about the service to the user at the notification timings determined for each of the plurality of services by the determination part 123 (S15). For example, the notification part 124 transmits the service information to the user terminal 2 or the associate terminal 3 using email, a messaging service, an SNS, or the like, on condition that the notification timing determined by the determination part 123 is reached. Further, the notification part 124 may output, to a printing apparatus, information for printing the service information on a paper medium and sending the service information to the user or a user's associate.

### [Effect of Embodiment]

In the information processing system S according to the present embodiment, the information processing apparatus 1 determines the classification of the user using the personal data of the user, and determines the notification timing according to the relationship between the determined classification and the service to be notified. In this way, the information processing apparatus 1 can notify the user about the information about the service offered at a timing suitable for the user.

### Second Embodiment

As a method different from that of the first embodiment, an information processing apparatus 1 according to the present embodiment determines the notification timing by comparing the reference value associated with the classification of the user with the measurement data of the user. Hereinafter, differences from the first embodiment will mainly be described. FIG. 9 is a schematic diagram for explaining a method by which the determination part 123 determines the notification timing.

The classification part 122 determines the classification of the user using the personal data acquired by the acquisition part 121. The classification part 122 may determine the classification of the user using the measurement data in addition to the personal data. The classification part 122 acquires the classification rules of each of the plurality of services stored in advance in the storage 11. In the present embodiment, the classification rules include the first rule for calculating the evaluation coefficient from the values included in the personal data and the measurement data, and the second rule for determining the classification of the user from the calculated evaluation coefficient, for example.

The classification part 122 calculates the evaluation coefficients of each of the plurality of services for which notification is to be provided from the personal data and the measurement data acquired by the acquisition part 121, according to the first rule among the acquired classification rules. The first rule is the table, shown in FIG. 4A, FIG. 4B, and FIG. 5, indicating the relationship between (i) the values of one or more types of personal data and the measurement data that are different among the plurality of services and (ii) the evaluation coefficients, for example.

The classification part 122 determines the classification of the user corresponding to the evaluation coefficients calculated in each of the plurality of services, according to the second rule among the acquired classification rules. The second rule is a table indicating a relationship between the range of the evaluation coefficients and the reference values, for example. The reference value is a threshold value used for comparison with the measurement data, and is represented by an amount of decrease in activity level (e.g., the number of steps), a nighttime sleep duration, an amount of decrease in physical function values (pulse), or the like.

The range of one evaluation coefficient in the second rule corresponds to the classification of one user. In the second rule, the classification part 122 determines the range in which the evaluation coefficients calculated in each of the plurality of services are included as the classification of the user in said services. Then, the classification part 122 acquires the reference values (X′1, X′2, and X′3 in FIG. 9) associated with the classification of the user in each of the plurality of services in the second rule.

The determination part 123 compares the values of the measurement data acquired by the acquisition part 121 with the reference value associated with the classification of the user determined by the classification part 122, and determines whether the values of the measurement data and the reference values satisfy a predetermined condition. For example, the determination part 123 determines, as the notification timing, a timing at which the value of the measurement data acquired by the acquisition part 121 exceeds the reference value associated with the classification of the user determined by the classification part 122. For example, the determination part 123 determines, as the notification timing, a timing at which the amount of decrease in the activity level exceeds the reference value, a timing at which the nighttime sleep duration exceeds the reference value, or a timing at which the amount of decrease in the value of the physical function exceeds the reference value.

The notification part 124 provides the service information to the user at a timing when the relationship between the value of the measurement data acquired by the acquisition part 121 and the reference value corresponding to the classification of the user determined by the classification part 122 satisfies a predetermined condition. For example, at the notification timings determined for each of the plurality of services by the determination part 123, the notification part 124 transmits service information about said services to the user terminal 2. The notification part 124 may provide the service information to the user's associate in addition to the user.

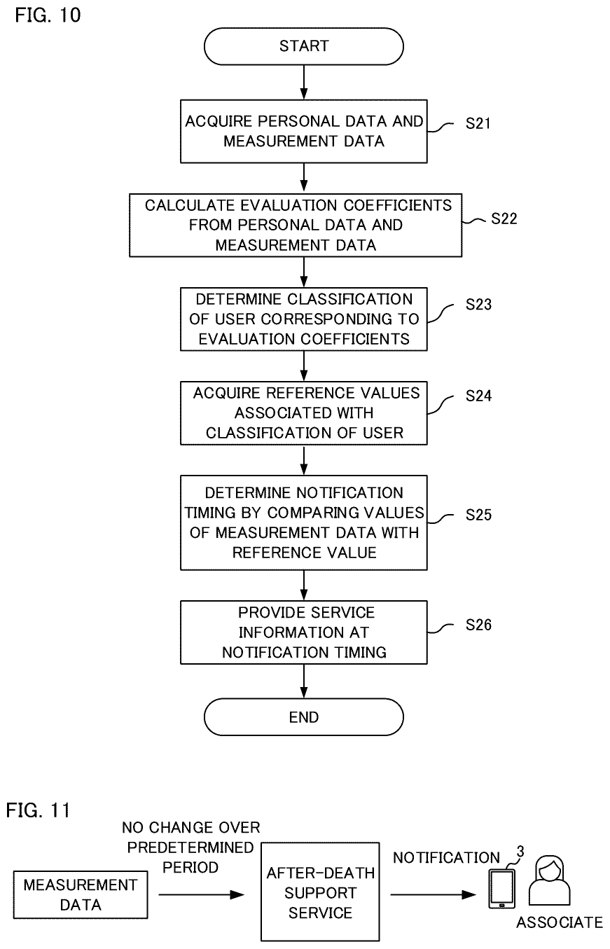

FIG. 10 is a flowchart of an information processing method executed by the information processing apparatus 1 according to the present embodiment. The acquisition part 121 acquires personal data indicating an attribute of a user and measurement data generated by measuring activities of the user (S21). The acquisition part 121 receives the personal data from a user terminal 2, an associate terminal 3, or another apparatus, for example. In addition, the acquisition part 121 receives the measurement data from the measurement apparatus 4 or another apparatus, for example.

The classification part 122 acquires the classification rules of each of the plurality of services stored in advance in the storage 11. The classification part 122 calculates evaluation coefficients of each of the plurality of services for which notification is to be provided from the personal data and the measurement data acquired by the acquisition part 121, according to the acquired classification rules (S22). The classification part 122 determines the classification of the user corresponding to the evaluation coefficients calculated in each of the plurality of services according to the acquired classification rules (S23).

The classification part 122 acquires reference values associated with the classification of the user in each of the plurality of services (S24). The determination part 123 determines a notification timing by comparing the values of the measurement data acquired by the acquisition part 121 with the reference value associated with the classification of the user determined by the classification part 122 (S25). For example, the determination part 123 determines, as the notification timing, a timing at which the value of the measurement data acquired by the acquisition part 121 exceeds the reference value associated with the classification of the user determined by the classification part 122.

The notification part 124 provides the service information about the service to the user at a timing (for example, the notification timings determined by the determination part 123 for each of the plurality of services) when the relationship between the value of the measurement data acquired by the acquisition part 121 and the reference value corresponding to the classification of the user determined by the classification part 122 satisfies a predetermined condition (S26). For example, the notification part 124 transmits the service information to the user terminal 2 or the associate terminal 3 using email, a messaging service, an SNS, or the like, on condition that the notification timing determined by the determination part 123 has been reached. Further, the notification part 124 may output, to a printing apparatus, information for printing the service information on a paper medium and sending the service information to the user or the user's associate.

As described above, the information processing apparatus 1 according to the present embodiment determines the classification of the user by using the personal data of the user, and determines the notification timing by comparing the reference value associated with the determined classification with the measurement data of the user. In this way, the information processing apparatus 1 can provide the information about the service offered to the user at a timing suitable for the user.

### Third Embodiment

An information processing apparatus 1 according to the present embodiment provides notification of, for example, service information about the after-death support service on the basis of the measurement data indicating that there is a possibility that the user has passed away. The notification in the present embodiment may be performed independently or in parallel with the notifications in the first embodiment and the second embodiment. Hereinafter, differences from the first embodiment will mainly be described.

FIG. 11 is a schematic diagram for explaining a method of notification by the notification part 124. In a case where the measurement data acquired by the acquisition part 121 does not change for a predetermined period (for example, three days) or longer, or in a case where the acquisition part 121 cannot acquire the measurement data for a predetermined period or longer, the determination part 123 transmits survival confirmation information for confirming whether or not the user is alive to the user terminal 2 or the associate terminal 3.

When an operation indicating that the user is alive is performed on the user terminal 2 or the associate terminal 3 that has received the survival confirmation information, the notification part 124 ends the process without transmitting the service information.

When an operation indicating that the user is not alive is performed on the user terminal 2 or the associate terminal 3 that has received the survival confirmation information, or when an operation indicating that the user is alive has not been performed within a predetermined period (for example, three days), the notification part 124 notifies the user's associate of the service information about the after-death support service. The notification part 124 transmits the service information about the after-death support service to the associate terminal 3 using email, a messaging service, an SNS, or the like, for example. Further, the notification part 124 may output, to a printing apparatus, information for printing the service information on a paper medium and sending the service information to the user's associate.

As described above, the information processing apparatus 1 according to the present embodiment can automatically notify the user's associate of the service information about the after-death support service on condition that the measurement data indicates that there is a possibility that the user has passed away, and can assist the user's associate with actions and tasks he/she has to take after the death of the user.

The present disclosure has been described above on the basis of the exemplary embodiments. The technical scope of the present disclosure is not limited to the scope explained in the above embodiments, and it is obvious to those skilled in the art that various changes and modifications within the scope of the disclosure may be made. An aspect to which such changes and modifications are added can be included in the technical scope of the present disclosure is obvious from the description of the claims.

The processor of the information processing apparatus 1 executes the steps (processes) included in the information processing method shown in FIGS. 8 and 10. That is, the processor of the information processing apparatus 1 executes the information processing method shown in FIGS. 8 and 10 by reading the programs for executing the information processing method illustrated in FIGS. 8 and 10 from the storage and executing the programs to control the respective parts of the information processing system. The steps included in the information processing method shown in FIGS. 8 and 10 may be partially omitted, the order of the steps may be changed, or a plurality of steps may be performed in parallel.

What is claimed is:

1. An information processing apparatus comprising:
an acquisition part that acquires personal data indicating an attribute of a user;
a classification part that determines a classification of the user by using the personal data;
a determination part that determines a timing at which information about a service offered to the user is provided as notification, the timing corresponding to a relationship between the classification and the service; and
a notification part that provides the information about the service to the user at the timing.

2. The information processing apparatus according to claim 1, wherein the acquisition part acquires a plurality of types of the personal data, and the classification part determines the classification in each of the plurality of services using one or a plurality of types of the personal data that are different among a plurality of the services.

3. The information processing apparatus according to claim 1, wherein the classification part calculates an evaluation coefficient from values of the personal data and determines the classification corresponding to the calculated evaluation coefficient.

4. The information processing apparatus according to claim 3, wherein the classification part calculates a plurality of the evaluation coefficient that are different among the plurality of the services associated with the values of the personal data.

5. The information processing apparatus according to claim 1, wherein the determination part determines, as the timing, a value calculated by subtracting a correction value associated with the classification from a reference value associated with the service.

6. The information processing apparatus according to claim 1, wherein the greater an amount of assets of the user indicated by the personal data, the earlier the determination part sets the timing, and the lesser the amount of assets, the later the determination part sets the timing.

7. The information processing apparatus according to claim 1, wherein the determination part sets the timing to be earlier for the user who is living alone, as indicated by the personal data, than for the user who is not living alone, as indicated by the personal data.

8. The information processing apparatus according to claim 1, wherein the classification part determines the classification using measurement data generated by measuring activities of the user in addition to the personal data.

9. The information processing apparatus according to claim 8, wherein the classification part determines the classification corresponding to an amount of change in the measurement data over a predetermined period.

10. The information processing apparatus according to claim 1, wherein the notification part switches a notification recipient of the information about the service between the user and an associate, who is associated with the user, in accordance with each of the plurality of services.

11. The information processing apparatus according to claim 1, wherein the notification part provides information determined according to the personal data to the user, the information being the information about the service.

12. The information processing apparatus according to claim 1, further comprising:
a changing part that changes rules used by the classification part to classify the user according to whether the user has used the service, after the notification part has provided the information about the service to the user.

13. An information processing method executed by a processor and comprising:
acquiring personal data indicating an attribute of a user;
determining a classification of the user by using the personal data;
determining a timing at which information about a service offered to the user is provided as notification, the timing corresponding to a relationship between the classification and the service; and
providing the information about the service to the user at the timing.

14. An information processing apparatus comprising:
an acquisition part that acquires personal data indicating an attribute of a user and measurement data generated by measuring activities of the user,
a classification part that determines a classification of the user using the personal data; and
a notification part that provides information about a service offered to the user at a timing when a relationship between a value of the measurement data and a reference value corresponding to the classification satisfies a predetermined condition.
